(19) United States
(12) Patent Application Publication
(10) Pub. No.: US 2023/0356156 A1
(43) Pub. Date: Nov. 9, 2023

(54) MEMBRANE COMPRISING AN AMORPHOUS POLYMER

(71) Applicant: BASF SE, Ludwigshafen am Rhein (DE)

(72) Inventors: Martin WEBER, Ludwigshafen am Rhein (DE); Christian MALETZKO, Ludwigshafen am Rhein (DE); Florian HENNENBERGER, Ludwigshafen am Rhein (DE); Axel WILMS, Frankenthal (DE)

(21) Appl. No.: 18/022,531

(22) PCT Filed: Aug. 24, 2020
(86) PCT No.: PCT/EP2020/073600

§ 371 Date: Feb. 22, 2023

(51) Int. Cl. B01D 71/80; B01D 69/02; B01D 67/00; B01D 71/52; B01D 71/68

(52) U.S. Cl. CPC B01D 71/80; B01D 69/02; B01D 67/0009; B01D 71/52; B01D 71/68; B01D 2325/30; B01D 2325/0231; B01D 2325/34; B01D 2323/12; B01D 2323/219

(57) ABSTRACT

The present invention relates to a membrane (M) comprising an amorphous polymer (P) comprising repeat units of the formulas (RU1), (RU2) and (RU3). Moreover, the present invention relates to a process for the preparation of said membrane (M) and a filtration process, wherein a liquid permeates said membrane (M).

The present invention relates to a membrane (M) comprising an amorphous polymer (P) comprising repeat units of the formulas (RU1), (RU2) and (RU3). Moreover, the present invention relates to a process for the preparation of said membrane (M) and a filtration process, wherein a liquid permeates said membrane (M).

The most common polymeric membranes for water filtration are based on cellulose acetate, polysulfone (PSU), polyethersulfone (PESU), polyvinylidenedifluoride (PVDF) and polyphenylsulfone (PPSU). Polysulfone (PSU), polyethersulfone (PESU) and poly-phenylsulfone (PPSU) are polyarylene ether sulfone polymers.

Polyarylene ether sulfone polymers are high-performance thermoplastics in that they feature high heat resistance, good mechanical properties and inherent flame retardancy (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190). Polyarylene ethers are highly biocompatible and so are also used as material for forming dialysis membranes (N. A. Hoenich, K. P. Katapodis, Biomaterials 23 (2002) 3853).

Polyarylene ether sulfone polymers can be formed inter alia either via the hydroxide method, wherein a salt is first formed from the dihydroxy component and the hydroxide, or via the carbonate method.

General information regarding the formation of polyarylene ether sulfone polymers by the hydroxide method is found inter alia in R. N. Johnson et. al., J. Polym. Sci. A-1 5 (1967) 2375, while the carbonate method is described in J. E. McGrath et. al., Polymer 25 (1984) 1827.

Methods of forming polyarylene ether sulfone polymers from aromatic bishalogen compounds and aromatic bisphenols or salts thereof in an aprotic solvent in the presence of one or more alkali metal or ammonium carbonates or bicarbonates are known to a person skilled in the art and are described in EP-A 297 363 for example.

High-performance thermoplastics such as polyarylene ether sulfone polymers are formed by polycondensation reactions which are typically carried out at a high reaction temperature in dipolar aprotic solvents, for example dimethylformamide (DMF), dimethylacetamide (DMAc), sulfolane, dimethylsulfoxide (DMSO) and N-Methyl-2-pyrrolidone (NMP).

Applications of polyarylene ether sulfone polymers in polymer membranes are increasingly important.

WO 2015/056145 discloses membranes containing a polyether (A) containing PPSU repeating units of the formula (3).

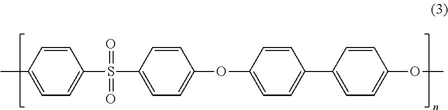

The polymer membrane according to WO 2015/056145 is used in a filtration process, especially for water filtration. Moreover, WO 2015/056145 discloses a method for the preparation of membranes, preferably of asymmetric polymer membranes containing a dense layer and a supporting layer.

Polyarylene ether sulfone polymers are amorphous. The amorphous polyarylene ether sulfone polymers show, compared to semi-crystalline polymers like polyphenylene sulfides, an inferior resistance against organic fluids like FAM B (toluene containing test fluid) or Skydrol (mixture of phosphates).

In order to improve the resistance against organic solvents, EP 2 225 328 describes semi-crystalline polymers containing sulfonyl groups, ketone groups and polyarylene groups. According to EP 2 225 328, preferably 4,4′-dichlorodiphenyl sulfone, 4,4′-dichlorobenzophenone and 4,4′-dihydroxybiphenyl are reacted in diphenylsulfone in order to obtain the semi-crystalline polymer. The melting temperature of the semi-crystalline polymers according to EP 2 225 328 is above 300° C. The polymers described in EP 2 225 328, however, show poor solubility in common solvents like N-methylpyrrolidone (NMP) or dimethylacetamide (DMAc) and, therefore, problems occur when these polymers are used to produce membranes via phase inversion.

Moreover, the polymers described in EP 2 225 328 are not transparent.

The present invention thus has for its object to provide a membrane (M) which does not retain the disadvantages of the prior art or only in diminished form. The membrane (M) should show a good chemical resistance against organic solvents like alcohols or ketones. Furthermore, improved stability against cleaning chemicals like aqueous NaOCl-solutions should be achieved. Moreover, the membranes (M) should show good permeability for water. Another object of the present invention is to provide a method for the preparation of said membrane (M). The process should preferably be performed easily with short preparation times. Moreover, the method should give a good control of the pore size of the membrane (M). Another object of the present invention is to provide a filtration process, wherein the membrane (M) is used.

This object is achieved by the membrane (M) comprising an amorphous polymer (P) comprising repeat units of the formulas (RU1), (RU2) and (RU3).

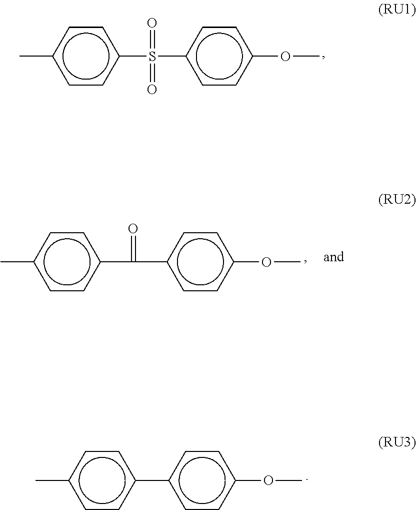

It has surprisingly been found that the membrane (M) comprising the amorphous polymer (P) shows a good chemical resistance against organic solvents Ethanole or Acetone and, moreover, that the membrane (M) shows a good permeability, especially for water. The membranes also show improved resistance against NaOCl-solutions.

The present invention will be described in more detail hereinafter.

Membrane (M)

The membrane (M) comprises an amorphous polymer (P). The amorphous polymer (P) comprises repeat units of the formulas (RU1), (RU2) and (RU3) as defined above.

The membrane (M) according to the invention can be symmetric or asymmetric. In a preferred embodiment, the membrane (M) is asymmetric, preferably obtained from a solution (S) comprising the amorphous polymer (P) in a phase inversion process.

The water permeability of the membrane (M) according to the invention is preferably at least 100 kg/m²*h*bar. More preferably, the water permeability is at least 150 kg/m²*h*bar. The water permeability is preferably at most 1500 kg/m²*h*bar.

In case the membrane (M) according to the invention is asymmetric, the membrane (M) typically comprises a filtration layer and a supporting layer which is in touch with the filtration layer.

The filtration layer is located at the upper surface of the membrane (M). The upper surface of the membrane (M) generally comprises pores with pore sizes between 0.001 and 1.0 μm, preferably between 0.005 and 0.5 μm, more preferred between 0.01 and 0.3 μm and most preferred between 0.01 and 0.1 μm. The filtration layer comprises the above mentioned pores in form of a mesh-like polymer network structure.

A filtration layer which is too thin is not preferable because it provides causes for the occurrence of pinholes. A filtration layer which is too thick limits the water permeation and, therefore, does not give good permeability results.

The supporting layer is located at the lower surface of the membrane (M). The lower surface of the membrane (M) generally comprises pores with a pore sizes preferably between >1 and 100 μm. The supporting layer also shows a mesh-like polymer network structure comprising pores. The supporting layer is in touch with the filtration layer. Preferably the pore sizes increases from the upper surface of the membrane (M) towards the lower surface of the membrane (M).

Another object of the present invention therefore is a membrane (M) that comprises an upper surface comprising pores, and a lower surface comprising pores, wherein the pore sizes increase from the upper surface towards the lower surface.

The pore sizes of the upper side of the membrane (M) and the lower side of the membrane can be measured via atomic force microscopy (AFM), transmission electron microscopy (TEM) or scaning electron micrisocopy (SEM).

The pores of the membrane (M) usually have a diameter in the range from 1 nm to 10000 nm, preferably in the range from 2 to 500 nm and particularly preferably in the range from 5 to 250 nm, determined via filtration experiments using a solution containing different PEG's covering a molecular weight from 300 to 1 000 000 g/mol. By comparing the GPC-traces of the feed and the filtrate, the retention of the membrane for each molecular weight can be determined. The molecular weight, where the membrane shows a 90% retention is considered as the molecular weight cutoff (MWCO) for this membrane under the given conditions. Using the known correlation between the Stoke diameters of PEG and their molecular weights, the mean pore size of a membrane can be determined. Details about this method are given in the literature (Chung, J. Membr. Sci. 531 (2017) 27-37).

The membrane (M) comprising the filtration layer and the supporting layer exhibits a sufficiently high mechanical strength. The thickness of the membrane (M) is preferably from 30 to 2000 μm, more preferably from 30 to 1000 μm.

The membrane (M) according to the invention can be a film (flat sheet membrane) or a cylindrical channel (hollow fiber membrane). Preferably the membrane (M) is a cylindrical channel. In a more preferred embodiment, the membrane (M) is a cylindrical multiple-channel membrane. The diameters of the channels, preferably of the multiple-channel membrane according to the invention, are generally between 0.1 and 8 mm, preferably between 0.1 and 6 mm. The thickness of the walls of the channel membranes contained in the multiple-channel membrane is generally between 0.05. and 1.5 mm, preferably between 0.1 and 0.5 mm. The cylindrical multiple-channel membrane generally contains at least three channels, preferably 7 to 19 channels. The overall diameter of the cylindrical multiple-channel membrane is generally between 4 and 10 mm.

Further constituents can be comprised in the membrane (M), which are different from the amorphous polymer (P). The optional further constituents may be selected from the group consisting of polyvinyl pyrrolidone, polyvinyl acetates, cellulose acetates, polyacrylonitriles, polyamides, polyolefines, polyesters, polysulfones, polyether-sulfones, polycarbonates, polyether ketones, sulfonated polyether ketones, sulfonated polyaryl ethers, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyvinylidene fluorides, polyamides, cellulose acetate, polyethylenglycols, polyvinyl pyrrolidone and mixtures thereof.

In a preferred embodiment, the membrane (M) does not contain further constituents.

The membrane (M) comprises preferably at least 70% by weight of the amorphous polymer (P), more preferably at least 80% by weight, most preferably at least 90% by weight and particularly preferred at least 95% by weight of the amorphous polymer (P) based on the total weight of the membrane (M).

In a further preferred embodiment, the membrane (M) consists essentially of the amorphous polymer (P).

“Consisting essentially of” means that the membrane (M) comprises more than 99% by weight, preferably more than 99.5% by weight and most preferably more than 99.9% by weight of the amorphous polymer (P) based on the total weight of the membrane (M).

During the formation of the membrane (M), the amorphous polymer (P) is separated from the at least one solvent. In a preferred embodiment the obtained membrane (M) is essentially free from the at least one solvent.

“Essentially free” within the context of the present invention means that the membrane (M) comprises at most 1% by weight, preferably at most 0.5% by weight and particularly preferably at most 0.1% by weight of the at least one solvent based on the total weight of the membrane (M). The membrane (M) comprises at least 0.0001% by weight, preferably at least 0.001% by weight and particularly preferably at least 0.01% by weight of the at least one solvent based on the total weight of the membrane (M).

During the preparation of the membrane (M), the solvent exchange usually leads to an asymmetric membrane structure. This is known to the skilled person. Therefore, the membrane (M) is preferably asymmetric. In an asymmetric membrane, the pore size increases from the upper surface of the membrane (M), which is used for separation, to the lower surface of the membrane which is used to support the membrane (M).

Another object of the present invention is therefore a membrane (M) wherein the membrane (M) is asymmetric.

Membrane (M) Preparation

A membrane (M) can be prepared from the amorphous polymer (P) according to the present invention by any method known to the skilled person.

Preferably, a membrane (M) comprising the amorphous polymer (P) is prepared by a method comprising the steps
i) providing a solution (S) which comprises the amorphous polymer (P) and at least one solvent,
ii) separating the at least one solvent from the solution (S) to obtain the membrane (M).

Another object of the present invention is therefore a method for the preparation of an inventive membrane (M), wherein the method comprises the steps
i) providing a solution (S) which comprises the amorphous polymer (P) and at least one solvent,
ii) separating the at least one solvent from the solution (S) to obtain the membrane (M).

Step i)

In step i) a solution (S) is provided which comprises the amorphous polymer (P) and at least one solvent.

“At least one solvent” within the context of the present invention means precisely one solvent also a mixture of two or more solvents.

The solution (S) can be provided in step i) by any method known to the skilled person. For example, the solution (S) can be provided in step i) in customary vessels which may comprise a stirring device and preferably a temperature control device. Preferably, the solution (S) is provided by dissolving the amorphous polymer (P) in the at least one solvent.

The dissolution of the amorphous polymer (P) in the at least one solvent to provide the solution (S) is preferably affected under agitation.

Step i) is preferably carried out at elevated temperatures, especially in the range from 20 to 120° C., more preferably in the range from 40 to 100° C. A person skilled in the art will choose the temperature in accordance with the at least one solvent.

The solution (S) preferably comprises the amorphous polymer (P) completely dissolved in the at least one solvent. This means that the solution (S) preferably comprises no solid particles of the amorphous polymer (P). Therefore, the amorphous polymer (P) preferably cannot be separated from the at least one solvent by filtration.

The solution (S) preferably comprises from 0.001 to 50% by weight of the amorphous polymer (P) based on the total weight of the solution (S). More preferably, the solution (S) in step i) comprises from 0.1 to 30% by weight of the amorphous polymer (P) and most preferably the solution (S) comprises from 0.5 to 25% by weight of the amorphous polymer (P) based on the total weight of the solution (S).

Another object of the present invention is therefore also a method for the preparation of a membrane (M) wherein the solution (S) in step i) comprises from 0.1 to 30% by weight of the amorphous polymer (P), based on the total weight of the solution (S).

As the at least one solvent, any solvent known to the skilled person for the amorphous polymer (P) is suitable. Preferably, the at least one solvent is soluble in water. Therefore, the at least one solvent is preferably selected from the group consisting of N-methylpyrrolidone, dimethyllactamide, N,N′-dimethylacetamide, dimethylsulfoxide, dimethylformamide and sulfolane. N-methylpyrrolidone and N,N′-dimethylactamide are particularly preferred. N-methylpyrrolidone is most preferred as the at least one solvent.

Another object of the present invention is therefore also a method for the preparation of a membrane (M) wherein the at least one solvent is selected from the group consisting of N-methylpyrrolidone, N,N′-dimethylacetamide, dimethyl sulfoxide, dimethylformamide and sulfolane.

The solution (S) preferably comprises in the range from 50 to 99.999% by weight of the at least one solvent, more preferably in the range from 70 to 99.9% by weight and most preferably in the range from 75 to 99.5% by weight of the at least one solvent based on the total weight of the solution (S).

The solution (S) provided in step i) can furthermore comprise additives for the membrane preparation.

Suitable additives for the membrane preparation are known to the skilled person and are, for example, polyvinylpyrrolidone (PVP), polyethylene oxide (PEO), polyethylene oxide-polypropylene oxide copolymer (PEO-PPO) and poly(tetrahydrofurane) (poly-THF). Polyvinylpyrrolidone (PVP) and polyethylene oxide (PEO) are particularly preferred as additives for the membrane preparation.

The additives for membrane preparation can, for example, be comprised in the solution (S) in an amount of from 0.01 to 20% by weight, preferably in the range from 0.1 to 15% by weight and more preferably in the range from 1 to 10% by weight based on the total weight of the solution (S).

To the person skilled in the art it is clear that the percentages by weight of the amorphous polymer (P) the at least one solvent and the optionally comprised additive for membrane preparation comprised in the solution (S) typically add up to 100% by weight.

The duration of step i) may vary between wide limits. The duration of step i) is preferably in the range from 10 min to 48 h (hours), especially in the range from 10 min to 24 h and more preferably in the range from 15 min to 12 h. A person skilled in the art will choose the duration of step i) so as to obtain a homogeneous solution of the amorphous polymer (P) in the at least one solvent.

For the amorphous polymer (P) comprised in the solution (S) the embodiments and preferences given for the amorphous polymer (P) obtained in the inventive process hold true respectively.

Before step ii) is conducted, in a preferred embodiment the solution (S) is degassed to improve the quality of the membrane (M). The degassing can be performed by vacuum degassing, ultrasonic degassing or be degassing by slow stirring.

In step ii) the at least one solvent is separated from the solution (S) to obtain the membrane (M). It is possible to filter the solution (S) provided in step i) before the at least one solvent is separated from the solution (S) in step ii) to obtain a filtered solution (fS). The following embodiments and preferences for separating the at least one solvent from the solution (S) applies equally for separating the at least one solvent from the filtered solution (fS) which is used in this embodiment of the invention.

The separation of the at least one solvent from the solution (S) can be performed by any method known to the skilled person which is suitable to separate solvents from polymers.

Preferably, the separation of the at least one solvent from the solution (S) is carried out via a phase inversion process. This process is known to the person skilled in the art. Preferably the phase inversion is carried out as a non solvent induced phase inversion process (NIPS-process).

Another object of the present invention is therefore also a method for the preparation of a membrane (M), wherein the separation of the at least one solvent in step ii) is carried out via a phase inversion process.

If the separation of the at least one solvent is carried out via a phase inversion process, the obtained membrane (M) is typically a porous membrane.

A phase inversion process within the context of the present invention means a process wherein the dissolved amorphous polymer (P) is transformed into a solid phase. Therefore, a phase inversion process can also be denoted as precipitation process. According to step ii) the transformation is performed by separation of the at least one solvent from the amorphous polymer (P). The person skilled in the art knows suitable phase inversion processes.

The phase inversion process can, for example, be performed by cooling down the solution (S). During this cooling down, the amorphous polymer (P) comprised in this solution (S) precipitates. Another possibility to perform the phase inversion process is to bring the solution (S) in contact with a gaseous liquid that is a non-solvent for the amorphous polymer (P). The amorphous polymer (P) will then as well precipitate. Suitable gaseous liquids that are non-solvents for the amorphous polymer (P) are for example protic polar solvents, described hereinafter, in their gaseous state.

Another phase inversion process which is preferred within the context of the present invention is the phase inversion by immersing the solution (S) into at least one protic polar solvent.

Therefore, in one embodiment of the present invention, in step ii) the at least one solvent comprised in the solution (S) is separated from the amorphous polymer (P) comprised in the solution (S) by immersing the solution (S) into at least one protic polar solvent.

This means that the membrane (M) is formed by immersing the solution (S) into at least one protic polar solvent.

Suitable at least one protic polar solvents are known to the skilled person. The at least one protic polar solvent is preferably a non-solvent for the amorphous polymer (P).

Preferred at least one protic polar solvents are water, methanol, ethanol, n-propanol, iso-propanol, glycerol, ethyleneglycol and mixtures thereof.

Step ii) usually comprises a provision of the solution (S) in a form that corresponds to the form of the membrane (M) which is obtained in step ii).

Therefore, in one embodiment of the present invention step ii) comprises a casting of the solution (S) to obtain a film of the solution (S) or a passing of the solution (S) through at least one spinneret to obtain at least one cylindrical channel (hollow fiber) of the solution (S).

Therefore, in one preferred embodiment of the present invention, step ii) comprise the following steps:
ii-1) casting the solution (S) provided in step i) to obtain a film of the solution (S),
ii-2) immersing the at least one solvent from the film of the solution (S) obtained in step ii-1) into at least one protic solvent to obtain the membrane (M) which is in the form of a film.

This means that the membrane (M) is formed by immersing the at least one solvent from a film of the solution (S) into at least one protic solvent.

In another preferred embodiment of the present invention, step ii) comprise the following steps:
iia-1) passing of the solution (S) through at least one spinneret to obtain at least one cylindrical channel of the solution (S),
iia-2) immersing the at least one solvent from the at least one cylindrical channel of the solution (S) obtained in step iia-1) into at least one protic solvent to obtain the membrane (M) which is in the form of cylindrical channel.

This means that the membrane (M) is formed by immersing the at least one solvent from a cylindrical channel of the solution (S) into at least one protic solvent.

In steps ii-1) and iia) the solution (S) can be cast/spun by any method known to the skilled person. Usually, the solution (S) is cast/spun with a casting knife/spinneret that is heated to a temperature in the range from 20 to 150° C., preferably in the range from 40 to 100° C.

The solution (S) is usually cast on a substrate that does not react with the amorphous polymer (P) or the at least one solvent comprised in the solution (S).

Suitable substrates are known to the skilled person and are, for example, selected from glass plates and polymer fabrics such as non-woven materials.

To obtain a dense membrane, the separation in step ii) is typically carried out by evaporation of the at least one solvent comprised in the solution (S).

Amorphous Polymer (P)

The amorphous polymer (P) according to the present invention generally comprises the above defined repeat units (RU1), (RU2) and (RU3). The repeat units (RU1), (RU2) and (RU3) may be present in the amorphous polymer (P) according to the present invention in its backbone, in its chain ends and/or in its repeat units. Preferably, the repeat units (RU1), (RU2) and (RU3) are comprised in backbone of the amorphous polymer (P).

In a preferred embodiment, the amorphous polymer (P) comprises 80 to 90% by mol, more preferably 80.1 to 89% by mol, even more preferably 80.2 to 88% by mol, particularly preferred 80.3 to 87% by mol, and most preferred 80.4 to 86.5% by mol of repeat units (RU1) and 10 to 20% by mol, more preferably 11 to 19.9% by mol, even more preferably 12 to 19.8% by mol, particularly preferred 13 to 19.7% by mol, and most preferred 13.5 to 19.6% by mol of repeat units (RU2), in each case based on the total number of moles of repeat units (RU1) and repeat units (RU2) comprised in the amorphous polymer (P).

Therefore, another object of the present invention is a membrane (M), wherein the amorphous polymer (P) comprises
80 to 90% by mole of repeat units (RU1), and 10 to 20% by mole of repeat units (RU2),
based on the total number moles of repeat unit (RU1) and repeat unit (RU2), comprised in the amorphous polymer.

In another preferred embodiment, the number of moles of repeat units (RU1) over the number of moles of repeat units (RU2) ratio contained in the amorphous polymer (P) is from 4 to 9, more preferably from 4.02 to 8.09, even more preferably from 4.05 to 7.33, particularly preferred from 4.08 to 6.69, and most preferred from 4.10 to 6.41.

The term “amorphous” in view of the amorphous polymer (P) according to the invention in a preferred embodiment is defined as follows. In a preferred embodiment, the term “amorphous” means that the amorphous polymer (P) has a melting enthalpy ΔHₘ in the range of 0 to 5 W/g, preferably in the range of 0 to 4 W/g, even more preferably in the range of 0 to 3 W/g, particularly preferred in the range of 0 to 2.5 W/g, and most preferred in the range of 0 to 2 W/g. In another most preferred embodiment, the amorphous polymer (P) does not show a melting point. In this case the melting enthalpy ΔHₘ is 0. The abbreviation W/g means watt per gram.

The term “amorphous” in view of the amorphous polymer (P) according to the invention in a preferred embodiment, moreover, is defined as follows. In a preferred embodiment, the term “amorphous”, moreover, means that the amorphous polymer (P) has a crystallization enthalpy ΔHₘ in the range of 0 to 5 W/g, preferably in the range of 0 to 4 W/g, even more preferably in the range of 0 to 3 W/g, particularly preferred in the range of 0 to 2.5 W/g, and most preferred in the range of 0 to 2 W/g. In another most 30 preferred embodiment, the amorphous polymer (P) does not show a crystallization point. In this case the crystallization enthalpy ΔHₘ is 0. The abbreviation W/g means watt per gram.

The melting enthalpy ΔHₘ (if any) and the crystallization enthalpy ΔH_{c} (if any) are determined via DSC (differential scanning calorimetry) starting at 20° C. heating the a sample of the amorphous polymer (P) with a rate of 20 K/min up to a temperature of 360° C., followed by cooling with a rate of >100 K/min down to 20° C., followed by a second heating with a rate of 20 K/min up to 360° C. followed by a second cooling with a rate of >100 K/min down to 20° C., wherein the melt enthalpy ΔHₘ and the crystallization enthalpy ΔH_{c} are determined during the second heating and the second cooling. If the amorphous polymer (P) is annealed at 250° C. for 0.5 hours, it is in some cases possible that via DSC a small phase transition (melting point) can be detected, showing a melt enthalpy ΔHₘ in the range of 0.1 to <4 W/g. If the amorphous polymer (P) is annealed at 250° C. for 0.5 hours, moreover, it is in some cases possible that via DSC a small phase transition (crystallization point) can be detected, showing a crystallization enthalpy ΔH_{c} in the range of 0.1 to <4 W/g.

Without annealing the amorphous polymer (P) in a preferred embodiment via DSC (using the above described method) no melting point can be detected. Without annealing the amorphous polymer (P), moreover, in a preferred embodiment via DSC (using the above described method) no crystallization point can be detected.

The amorphous polymer (P) has a polydispersity (Q) of generally ≤5, and preferably ≤4.5.

The polydispersity (Q) is defined as the ratio M_{w}:Mₙ (M_{w}/Mₙ). In one preferred embodiment, the polydispersity (Q) of the amorphous polymer (P) is in the range from 2.0 to ≤5 and preferably in the range from 2.1 to ≤4,5.

Another object of the present invention, therefore, is a membrane (M) wherein the amorphous polymer (P) has a polydiversity (Q) in the range of 2.0 to ≤5.0.

The weight average molecular weight (M_{w}) and the number average molecular weight (Mₙ) are measured using gel permeation chromatography.

The polydispersity (Q) and the average molecular weight of the amorphous polymer (P) were measured using gel permeation chromatography (GPC). Dimethylacetamide (DMAc) was used as solvent and narrowly distributed polymethyl methacrylate was used as standard in the measurement.

The amorphous polymer (P) can preferably have an average molecular weight Mn (number average) in the range from 7 500 to 60 000 g/mol, especially 8 000 to 45 000 g/mol, determined by means of gel permeation chromatography (GPC). The weight-average molar mass Mw of the amorphous polymer (P) may preferably be from 14 000 to 120 000 g/mol, in particular it may be from 18 000 to 100 000 g/mol and it may be particularly preferably be from 25000 to 80 000 g/mol, determined by GPC. Thereby Mn as well as Mw can be determined by GPC in dimethylacetamide as solvent against narrowly-distributed polymethyl methacrylate as standard (calibration between 800 to 1820000 g/mol), using 4 columns (pre-column, 3 separation columns based on polyester copolymers) operated at 80° C. and a flow rate set to 1 ml/min, injection volume of 100 μl. For detection an RI-detector can be employed.

The terminal groups of the amorphous polymer (P) are generally either halogen groups, in particular chlorine groups, or etherified groups, in particular alkyl ether groups. Etherified end groups are obtainable by reacting the terminal OH/phenoxide groups with suitable etherifying agents.

Examples of suitable etherifying agents are monofunctional alkyl or aryl halides, for example C₁-C₆ alkyl chlorides, bromides or iodides, preferably methyl chloride, or benzyl chloride, bromide or iodide, or mixtures thereof. The terminal groups of the polyarylene ether sulfone polymer according to the present invention are preferably halogen groups, in particular chlorine, and also alkoxy groups, in particular methoxy, aryloxy groups, in particular phenoxy, or benzyloxy.

The total weight of repeat units (RU1), (RU2) and (RU3) contained in the amorphous polymer (P) over the total weight of the amorphous polymer (P) ratio is advantageously above 0.7. This ratio is preferably above 0.8, more preferably above 0.9 and still more preferably above 0.95. Most preferably, the polymer according to the present invention comprises no other repeat units than repeat units (RU1), (RU2) and (RU3).

In a preferred embodiment, the amorphous polymer (P) is obtainable by the reaction of a 4,4′-dihalodiphenylsulfone, 4,4′-dihalobenzophenone and 4,4′-dihydroxybiphenole. The 4,4′-dihalodiphenylsulfone is preferably selected from the group consisting of 4,4′-dichlorodiphenylsulfone and 4,4′-diflourodiphenylsulfone, wherein 4,4′-dichlorodiphenylsulfone is preferred. The 4,4′-dihalobenzophenone is preferably selected from the group of 4,4′-dichlorobenzophenone and 4,4′-difluorobenzophenone, wherein 4,4′-dichlorobenzophenenone is preferred.

Another object of the present application, therefore, is a membrane (M) wherein the amorphous polymer (P) is obtainable by the reaction of a 4,4′-di-halogendiphenylsulfone, a 4,4′-dihalobenzophenone and 4,4′-dihydroxybiphenole.

The amorphous polymer (P) can be a statistical copolymer or a block copolymer. In a statistical copolymer, the repeat units (RU1), (RU2) and (RU3) follow a statistical rule. If the amorphous polymer (P) is a block copolymer, it comprises two homopolymer subunits linked by a covalent bond.

If the amorphous polymer (P) is a statistical copolymer, it generally comprises the following structures (S1) and (S2).

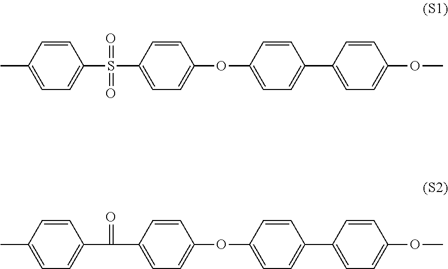

Another object of the present application, therefore, is a membrane (M) wherein the amorphous polymer (P) is a statistical copolymer having the following structures (S1) and (S2)

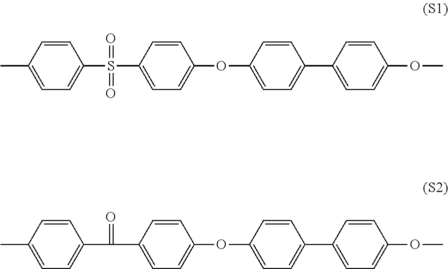

wherein the structures (S1) and (S2) follow a statistical rule.

Structure (S1) is derived from a 4,4′-dihalodiphenylsulfone monomer and a 4,4′-biphenole. Structure (S2) is derived from a 4,4′-dihalobenzophenone and 4,4′-biphenole.

If the amorphous polymer (P) is a block copolymer, it typically has the following structure (S3).

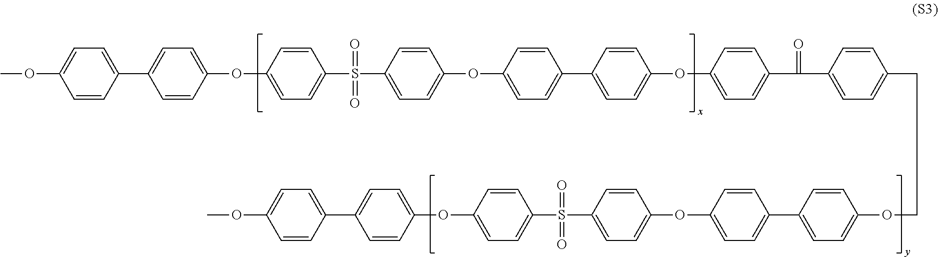

Another object of the present application, therefore, is a membrane (M) wherein the amorphous polymer (P) is a block copolymer having the following structure (S3)

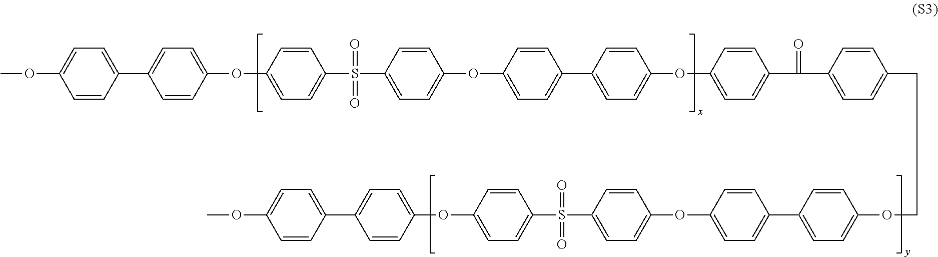

In structure (S3), x and y are preferably independently of each other in the range of 4.5 to 9, more preferably in the range of 4.5 to 8, even more preferably in the range of 4.5 to 7, particularly preferred in the range of 4.5 to 6 and most preferred in the range of 4.5 to 5. x and y denote the average length of the polymer blocks derived from the monomers 4,4′-dihalodiphenylsulfone and 4,4′-biphenole, also called polyphenylenesulfone blocks (PPSU blocks). If the amorphous polymer (P) is a block copolymer, the PPSU blocks are linked together via a benzophenone unit. The block copolymer is obtainable by the reaction of 4,4′-dihalodiphenylsulfone and 4,4′-biphenole in a first step, wherein a molar excess of 4,4′-biphenole is used to obtain a PPSU block having terminal hydroxy groups and reacting said PPSU blocks having terminal hydroxy groups in a second step with a 4,4′-dihalobenzophenone in order to obtain the block copolymer.

The average length of the polymer blocks x and y can be determined by potentiometric titration of the OH groups and elemental analysis of the organic Cl-content of the precipitated and dried sample taken from the reactor prior to the addition of 4,4′-dichlorobenzophenone. The calculated values correspond to the number average molecular weight of the oligomer.

The present invention is further elucidated by the following working examples without limiting it thereto.

Preferred methods for the preparation of the amorphous polymer (P) are described hereinafter.

A statistical amorphous polymer (P) can be prepared preferably by converting a reaction mixture (R_{G}) comprising as components:
(A1) at least one 4,4′-dihalodiphenylsulfone,
(A2) at least one 4,4′-dihalobenzophenone,
(B1) 4,4′-biphenol,
(C) at least one carbonate component comprising at least 80% by weight of potassium carbonate, based on the overall weight of component (C) in the reaction mixture (R_{G}),
(D) at least one aprotic polar solvent.

The aforementioned descriptions and preferences in view of the amorphous polymer (P) apply for the process for the preparation of the amorphous polymer (P) accordingly. Moreover, the descriptions and preferences made hereinafter in view of the process for the preparation of the amorphous polymer (P) apply for the amorphous polymer (P) accordingly.

The components (A1), (A2) and (B1) enter into a polycondensation reaction.

Component (D) acts as a solvent and component (C) acts as a base to deprotonate component (B1) prior or during the condensation reaction.

Reaction mixture (R_{G}) is understood to mean the mixture that is used in the process according to the present invention for preparing the amorphous polymer (P). In the present case all details given with respect to the reaction mixture (R_{G}) thus, relate to the mixture that is present prior to the polycondensation. The polycondensation takes place during the process according to the invention in which the reaction mixture (R_{G}) reacts by polycondensation of components (A1), (A2) and (B1) to give the target product, the amorphous polymer (P). The mixture obtained after the polycondensation which comprises the amorphous polymer (P) target product is also referred to as product mixture (P_{G}). The product mixture (P_{G}) usually furthermore comprises the at least one aprotic polar solvent (component (D)) and a halide compound. The halide compound is formed during the conversion of the reaction mixture (R_{G}). During the conversion first, component (C) reacts with component (B1) to deprotonate component (B1). Deprotonated component (B1) then reacts with component (A1) wherein the halide compound is formed. This process is known to the person skilled in the art.

In one embodiment of the present invention in step I) a first amorphous polymer (P1) is obtained. This embodiment is described in more detail below. In this embodiment the product mixture (P_{G}) comprises the first amorphous polymer (P1). The product mixture (P_{G}) then usually furthermore comprises the at least one aprotic polar solvent (component (D)) and a halide compound. For the halide compound the above described details hold true.

The components of the reaction mixture (R_{G}) are generally reacted concurrently. The individual components may be mixed in an upstream step and subsequently be reacted. It is also possible to feed the individual components into a reactor in which these are mixed and then reacted.

In the process according to the invention, the individual components of the reaction mixture (R_{G}) are generally reacted concurrently in step I). This reaction is preferably conducted in one stage. This means, that the deprotonation of component (B1) and also the condensation reaction between components (A1), (A2) and (B1) take place in a single reaction stage without isolation of the intermediate products, for example the deprotonated species of component (B1).

The process according to step I) of the invention is carried out according to the so called “carbonate method”. The process according to the invention is not carried out according to the so called “hydroxide method”. This means, that the process according to the invention is not carried out in two stages with isolation of phenolate anions.

It is furthermore preferred that the reaction mixture (R_{G}) does not comprise toluene or chlorobenzene. It is particularly preferred that the reaction mixture (R_{G}) does not comprise any substance which forms an azeotrope with water.

Another object of the present invention is therefore also a process wherein the reaction mixture (R_{G}) does not comprise any substance which forms an azeotrope with water.

The molar ratio of the sum of components (A1), (A2) and component (B1) (ratio (A1+A2)/(B1)) derives in principle from the stoichiometry of the polycondensation reaction which proceeds with theoretical elimination of hydrogen chloride and it is established by the person skilled in the art in a known manner.

Preferably, the molar ratio of component (B1) to the sum of components (A1) and (A2) is from 0.95 to 1.08, especially from 0.96 to 1.06, most preferably from 0.97 to 1.05.

Another object of the present invention is therefore also a process wherein the molar ratio of component (B1) to the sum of components (A1), (A2) in the reaction mixture (R_{G}) is in the range from 0.97 to 1.08.

In a preferred embodiment, the reaction mixture (R_{G}), additionally to components (A1),

(A2), (B1), (C) and (D), comprises at most 15% by weight, more preferred at most 7.5% by weight, particularly preferred at most 2.5% by weight and most preferred at most 1% by weight of further components which are different from components (A1), (A2), (B1), (C) and (D), based on the total weight of the reaction mixture (R_{G}).

In another most preferred embodiment, the reaction mixture (R_{G}) consists of the components (A1), (A2), (B1), (C) and (D).

Preferably, the conversion in the polycondensation reaction is at least 0.9.

Process step I) for the preparation of the amorphous polymer (P) is typically carried out under conditions of the so called “carbonate method”. This means that the reaction mixture (R_{G}) is reacted under the conditions of the so called “carbonate method”. The reaction (polycondensation reaction) is generally conducted at temperatures in the range from 80 to 250° C., preferably in the range from 100 to 220° C. The upper limit of the temperature is determined by the boiling point of the at least one aprotic polar solvent (component (D)) at standard pressure (1013.25 mbar). The reaction is generally carried out at standard pressure. The reaction is preferably carried out over a time interval of 2 to 12 h, particularly in the range from 3 to 10 h.

The isolation of the obtained amorphous polymer (P) obtained in the process according to the present invention in the product mixture (P_{G}) may be carried out for example by precipitation of the product mixture (P_{G}) in water or mixtures of water with other solvents. The precipitated amorphous polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

In one embodiment of the present invention, in step I) a first amorphous polymer (P1) is obtained. The inventive process then preferably additionally comprises step
II) reacting the first amorphous polymer (P1) obtained in step I) with an alkyl halide.

Another object of the present invention is therefore also a process, wherein in step I) a first amorphous polymer (P1) is obtained and wherein the process additionally comprises step
II) reacting the first amorphous polymer (P1) obtained in step I) with an alkyl halide.

To the person skilled in the art it is clear that if step II) is not carried out then the first amorphous polymer (P1) corresponds to the amorphous polymer (P).

The first amorphous polymer (P1) usually is the product of the polycondensation reaction of components (A1), (A2) and component (B1) comprised in the reaction mixture (R_{G}). The first amorphous polymer (P1) can be comprised in the above-described product mixture (P_{G}), which is obtained during the conversion of the reaction mixture (R_{G}). As described above, this product mixture (P_{G}) comprises the first amorphous polymer (P1), component (D) and a halide compound. The first amorphous polymer (P1) can be comprised in this product mixture (P_{G}) when it is reacted with the alkyl halide.

The separation of the halide compound from the first product mixture (P1) can be carried out by any method known to the skilled person, for example via filtration or centrifugation.

The first amorphous polymer (P1) usually comprises terminal hydroxy groups. In step II) these terminal hydroxy groups are further reacted with the alkyl halide to obtain the polyarylene ether sulfone polymer (P). Preferred alkyl halides are in particular alkyl chlorides having linear or branched alkyl groups having from 1 to 10 carbon atoms, in particular primary alkyl chlorides, particularly preferably methyl halides, in particular methyl chloride.

The reaction according to step II) is preferably carried out at a temperature in the range from 90° C. to 160° C., in particular in the range from 100° C. to 150° C. The time required can vary over a wide range of times and is usually at least 5 minutes, in particular at least 15 minutes. It is preferable that the time required for the reaction according to step II) is from 15 minutes to 8 hours, in particular from 30 minutes to 4 hours.

Various methods can be used for the addition of the alkyl halide. It is moreover possible to add a stoichiometric amount or an excess of the alkyl halide, and the excess can be by way of example by up to 5-fold. In one preferred embodiment the alkyl halide is added continuously, in particular via continuous introduction in the form of a gas stream.

In step II) usually a polymer solution (PL) is obtained which comprises the amorphous polymer (P) and component (D). If in step II) the product mixture (P_{G}) from step I) was used, then the polymer solution (PL) typically furthermore comprises the halide compound. It is possible to filter the polymer solution (PL) after step II). The halide compound can thereby be removed.

The present invention therefore also provides a process wherein in step II) a polymer solution (PL) is obtained and wherein the process furthermore comprises step
III) filtration of the polymer solution (PL) obtained in step II).

The isolation of the obtained amorphous polymer (P) obtained in the step II) according to the present invention in the polymer solution (PL) may be carried out as the isolation of the amorphous polymer (P) obtained in the product mixture (P_{G}). For example, the isolation may be carried out by precipitation of the polymer solution (PL) in water or mixtures of water with other solvents. The precipitated amorphous polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

Component (C)

The reaction mixture (R_{G}) comprises at least one carbonate component as component (C). The term “at least one carbonate component” in the present case, is understood to mean exactly one carbonate component and also mixtures of two or more carbonate components. The at least one carbonate component is preferably at least one metal carbonate. The metal carbonate is preferably anhydrous.

Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred.

For example, component (C) comprises at least 50% by weight, more preferred at least 70% by weight and most preferred at least 90% by weight of potassium carbonate based on the total weight of the at least one carbonate component in the reaction mixture (R_{G}).

Another object of the present invention is therefore also a process wherein component (C) comprises at least 50% by weight of potassium carbonate, based on the total weight of component (C).

In a preferred embodiment component (C) consists essentially of potassium carbonate.

“Consisting essentially of” in the present case is understood to mean that component (C) comprises more than 99% by weight, preferably more than 99.5% by weight, particular preferably more than 99.9% by weight of potassium carbonate based in each case on the total weight of component (C) in the reaction mixture (R_{G}).

In a particularly preferred embodiment component (C) consists of potassium carbonate.

Potassium carbonate having a volume weighted average particle size of less than 200 μm is particularly preferred as potassium carbonate. The volume weighted average particle size of the potassium carbonate is determined in a suspension of potassium carbonate in chlorobenzene/sulfolane (60/40) using a Malvern Mastersizer 2000 Instrument particle size analyser.

In a preferred embodiment, the reaction mixture (R_{G}) does not comprise any alkali metal hydroxides or alkaline earth metal hydroxides.

Component (D)

The reaction mixture (R_{G}) comprises at least one aprotic polar solvent as component (D). “At least one aprotic polar solvent”, according to the invention, is understood to mean exactly one aprotic polar solvent and also mixtures of two or more aprotic polar solvents.

Suitable aprotic polar solvents are, for example, selected from the group consisting of anisole, dimethylformamide, dimethylsulfoxide, N-methylpyrrolidone, N-ethylpyrrolidone, sulfolane and N,N-dimethylacetamide.

Preferably, component (D) is selected from the group consisting of N-methylpyrrolidone, N,N-dimethylacetamide, dimethylsulfoxide and dimethylformamide. N-methylpyrrolidone is particularly preferred as component (D).

Another object of the present invention is therefore also a process wherein component (D) is selected from the group consisting of N-methylpyrrolidone, N,N-dimethylacetamide, dimethylsulfoxide and dimethylformamide.

It is preferred that component (D) does not comprise sulfolane. It is furthermore preferred that the reaction mixture (R_{G}) does not comprise diphenyl sulfone.

It is preferred that component (D) comprises at least 50% by weight of at least one solvent selected from the group consisting of N-methylpyrrolidone, N,N-dimethylacetamide, dimethylsulfoxide and dimethylformamide based on the total weight of component (D) in the reaction mixture (R_{G}). N-methylpyrrolidone is particularly preferred as component (D).

In a further preferred embodiment, component (D) consists essentially of N-methylpyrrolidone.

“Consist essentially of”, in the present case, is understood to mean that component (D) comprises more than 98% by weight, particularly preferably more than 99% by weight, more preferably more than 99.5% by weight, of at least one aprotic polar solvent selected from the group consisting of N-methylpyrrolidone, N,N-dimethylacetamide, dimethylsulfoxide and dimethylformamide with preference given to N-methylpyrrolidone.

In a preferred embodiment, component (D) consists of N-methylpyrrolidone. N-methylpyrrolidone is also referred to as NMP or N-methyl-2-pyrrolidone.

For the preparation of an amorphous block copolymer (P), as described above, in a first step components (A1) and (B1) are reacted in the presence of components (C) and (D) to obtain the above defined PPSU blocks, having terminal OH-groups. In a second step, said PPSU blocks are reacted with component (A2) in the presence of components (C) and (D) in order to obtain the amorphous block copolymer (P). For the amorphous block copolymer (P), components (A1), (A2), (B1), (C) and (D), the above mentioned descriptions and preferences in view of the preparation of the statistical amorphous polymer (P) apply accordingly.

Filtration Process

Another object of the present invention is a filtration process, wherein a liquid, preferably water, permeates the membrane (M).

In a preferred embodiment, the filtration process is a water filtration process, for example for microfiltration, ultrafiltration, nanofiltration and/or reverse osmosis.

### EXAMPLES

Components used
DCDPS: 4,4′-dichlorodiphenylsulfone,
DCBPO: 4,4′-dichlorobenzophenone,
BP: 4,4′-biphenol,
Potassium carbonate: K2003; anhydrous; volume-average particle size of 34.5 μm,
NMP: N-methylpyrrolidone,
PPSU: polyphenylensulfone (ULTRASON® P 3010)
PESU: polyethersulfone (ULTRASON® E 3010)

As pore forming agent, polyvinylpyrrolidone K90 (BASF SE) was used.

General Procedures

The viscosity number of the polymers is determined in a 1% solution in NMP at 25° C., according to DIN EN ISO 1628-1.

The isolation of the polymers is carried out by dripping an NMP solution of the polymers in demineralized water at room temperature (25° C.). The drop height is 0.5 m, the throughput is about 2.5 I/h. The beads obtained are then extracted with water (water throughput 160 I/h) at 85° C. for 20 h. The beads are dried at 150° C. for 24 h (hours) at reduced pressure (<100 mbar) to a residual moisture of below 0.1% by weight.

The glass transition temperature (T_{g}) and the melting point of the obtained products is determined via differential scanning calorimetry DSC at a heating ramp of 20 K/min in the second heating cycle as described above.

The content of benzophenone groups is measured by ¹H-NMR using CDCl₃ as sovent.

Polymer V1

In a 4 liter glass reactor fitted with a thermometer, a gas inlet tube and a Dean-Stark-trap, 522.63 g (1.82 mol) of DCDPS, 372.41 g (2.00 mol) of 4,4′-dihydroxybiphenyl, 50.22 g (0.20 mol) 4,4′-dichlorobenzophenone, and 304.05 g (2.20 mol) of potassium carbonate with a volume average particle size of 34.5 pm were suspended in 1152 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, lost NMP was replaced.

At 190° C. the reaction was continued for another 5 h, then 1500 ml NMP were added to the reactor and the temperature of the suspension was adjusted to 135° C. (took 10 minutes). Then methylchloride was added to the reactor for 60 minutes. Then N₂ was purged through the suspension for another 30 minutes. The solution was then cooled to 80° C. and was then transferred into a pressure filter to separate the potassium chloride formed in the reaction by filtration. The obtained polymer solution was then precipitated in water, the resulting polymer beads were separated and then extracted with hot water (85° C.) for 20 h. Then the beads were dried at 120° C. for 24 h at reduced pressure (<100 mbar).

Amorphous Polymer 2

In a 4 liter glass reactor fitted with a thermometer, a gas inlet tube and a Dean-Stark-trap, 508.28 g (1.77 mol) of DCDPS, 372.41 g (2.00 mol) of 4,4′-dihydroxybiphenyl, 5 62.78 g (0.25 mol) of 4,4′-dichlorobenzophenon, and 304.05 g (2.20 mol) of potassium carbonate with a volume average particle size of 34.5 μm were suspended in 1152 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, lost NMP was replaced.

At 190° C. the reaction was continued for another 4.2 h, then 1500 ml NMP were added to the reactor and the temperature of the suspension was adjusted to 135° C. (took 10 minutes). Then methylchloride was added to the reactor for 60 minutes. Then N₂ was purged through the suspension for another 30 minutes. The solution was then cooled to 80° C. and was then transferred into a pressure filter to separate the potassium chloride formed in the reaction by filtration. The obtained polymer solution was then precipitated in water, the resulting polymer beads were separated and then extracted with hot water (85° C.) for 20 h. Then the beads were dried at 120° C. for 24 h at reduced pressure (<100 mbar).

Amorphous Polymer 3

In a 4 liter glass reactor fitted with a thermometer, a gas inlet tube and a Dean-Stark-trap, 493.91 g (1.72 mol) of DCDPS, 372.41 g (2.00 mol) of 4,4′-dihydroxybiphenyl, 75.33 g (0.30 mol) of 4,4′-dichlorobenzophenon, and 304.05 g (2.20 mol) of potassium carbonate with a volume average particle size of 34.5 μm were suspended in 1152 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, lost NMP was replaced.

At 190° C. the reaction was continued for another 5 h, then 1500 ml NMP were added to the reactor and the temperature of the suspension was adjusted to 135° C. (took 10 minutes). Then methylchloride was added to the reactor for 60 minutes. Then N₂ was purged through the suspension for another 30 minutes. The solution was then cooled to 80° C. and was then transferred into a pressure filter to separate the potassium chloride formed in the reaction by filtration. The obtained polymer solution was then precipitated in water, the resulting polymer beads were separated and then extracted with hot water (85° C.) for 20 h. Then the beads were dried at 120° C. for 24 h at reduced pressure (<100 mbar).

Polymer V2

In a 4 liter glass reactor fitted with a thermometer, a gas inlet tube and a Dean-Stark-trap, 450.86 g (1.57 mol) of DCDPS, 372.41 g (2.00 mol) of 4,4′-dihydroxybiphenyl, 113.00 g (0.45 mol) of 4,4′-dichlorobenzophenon, and 304.05 g (2.20 mol) of potassium carbonate with a volume average particle size of 34.5 μm were suspended in 1152 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, lost NMP was replaced.

At 190° C. the reaction was continued for another 6 h, then 1500 ml NMP were added to the reactor and the temperature of the suspension was adjusted to 135° C. (took 10 minutes). Then methylchloride was added to the reactor for 60 minutes. Then N₂ was purged through the suspension for another 30 minutes. The solution was then cooled to 80° C. and was then transferred into a pressure filter to separate the potassium chloride formed in the reaction by filtration. The obtained polymer solution was then precipitated in water, the resulting polymer beads were separated and then extracted with hot water (85° C.) for 20 h. Then the beads were dried at 120° C. for 24 h at reduced pressure (<100 mbar).

TABLE 1

| Example | V1 | 2 | 3 | V2 | PPSU |
|---|---|---|---|---|---|
| Content | 8.7 | 11.2 | 13.5 | 21* | 0 |
| BPO-units | | | | | |
| [mol %] | | | | | |
| VZ | 68.5 | 59.9 | 59.8 | Not sol. | 71.6 |
| [ml/g] | | | | in NMP | |
| Tg [° C.] | 211 | 208 | 207 | 200 | 219 |
| Tm [° C.] | — | — | — | 299 | — |
| ΔHm [J/g] | 0 | 0 | 0 | 5.2 | 0 |

*Solution not completely homogeneous

Preparation of Flat Sheet Membranes

Into a three-neck flask equipped with a magnetic stirrer there is added 76.9 ml of N-methylpyrrolidone (NMP), 6 g of polyvinylpyrrolidone (PVP, K90) and 17.1 g of polymer. The mixture is heated under gentle stirring at 60° C. until a homogeneous clear viscous solution is obtained. The solution is degassed overnight at room temperature.

After that the membrane solution is reheated at 60° C. for 2 hours and casted onto a glass plate with a casting knife (300 microns) at 60° C. using an Erichsen Coating machine operating at a speed of 5 mm/min. The membrane film is allowed to rest for 30 seconds before immersion in a water bath at 25° C. for 10 minutes.

After the membrane has detached from the glass plate, the membrane is carefully transferred into a water bath for 12 h. Afterwards the membrane is transferred into a bath containing 2500 ppm NaOCl at 50° C. for 4.5 h to remove PVP. After that process the membrane is washed with water at 60° C. (5 times) and one time with a 0.5 wt.-% solution of Na₂S₂O₃ to remove active chlorine. After several washing steps with water, the membrane was stored wet until characterization started.

In most cases a flat sheet continuous film with microstructural characteristics of UF membranes having dimension of at least 10×15 cm size is obtained. The membrane presents a top thin skin layer (1-10 microns) and a porous layer underneath (thickness: 130-180 microns).

Membrane Characterization

Using a pressure cell with a diameter of 60 mm, the pure water permeation of the membranes was tested using ultrapure water (salt-free water, filtered by a Millipore UF-system). In a subsequent test, a solution of different PEG-standards was filtered at a pressure of 0.15 bar. By GPC-measurement of the feed and the permeate, the molecular weight cut-off was determined.

The stability against organic compounds in the filtrate was tested by soaking parts of the membrane in acetone and water/ethanol-mixture 50/50 and assess the swelling of the membrane qualitatively (1: no swelling; 5: massive swelling).

Membranes were also aged in aqueous NaOCl-solutions for 7 days at 23° C. The solution had a content of free Chlorine of 2000 ppm at a pH of 8. The solutions were replaced after 1, 2 and 5 days.

Furthermore, stripes (length: 70 mm, width: 10 mm; thickness: 0.17 to 0.19 mm) were cut out of the aged membrane sheets. Then the samples were washed with water (5 times 100 ml), one time with Na₂S₂O₃-solution (100 ml), one time with water (100 ml) and stored in water until testing. Tensile testing on 5 samples of each material was run, the average of the tensile elongation is reported.

The obtained data are summarized in table 2.

TABLE 2

| Membrane | V1 | V2 | V3 | 4 | 5 |
|---|---|---|---|---|---|
| PESU | 17.1 | — | — | — | — |
| [wt.-%] | | | | | |
| PPSU | — | 17.1 | — | — | — |
| [wt.-%] | | | | | |
| Polymer V1 | — | — | 17.1 | — | — |
| [wt.-%] | | | | | |
| Amorphous polymer | — | — | — | 17.1 | — |
| (P) 2 [wt.-%] | | | | | |
| Amorphous polymer | — | — | — | — | 17.1 |
| (P) 3 [wt.-%] | | | | | |
| PVP K90 | 6 | 6 | 6 | 6 | 6 |
| [wt.-%] | | | | | |
| NMP | 76.9 | 76.9 | 76.9 | 76.9 | 76.9 |
| [wt.-%] | | | | | |
| PWP | 1150 | 930 | 1030 | 1100 | 1140 |
| [l/m²*h*bar] | | | | | |
| MWCO | 89 | 45 | 51 | 43 | 41 |
| [kg/mol] | | | | | |
| Swelling | | | | | |
| Acetone | 5 | 4 | 4 | 2 | 2 |
| Water/EtOH | 3 | 2 | 1 | 0 | 0 |
| Tensile elong. [%] | | | | | |
| Before | 35 | 39 | 31 | 32 | 30 |
| After | 9 | 18 | 14 | 24 | 25 |

Membranes based on PPSU-co-BPO-copolymers with a BPO-content of 10 to 20 mol-% show excellent stability against solvents and NaOCl-solution. Surprisingly, at comparable MWCO these membranes also show improved permeability (PWP).

1.-15. (canceled)

16. A membrane (M) comprising an amorphous polymer (P) comprising repeat units of the formulas (RU1), (RU2) and (RU3). 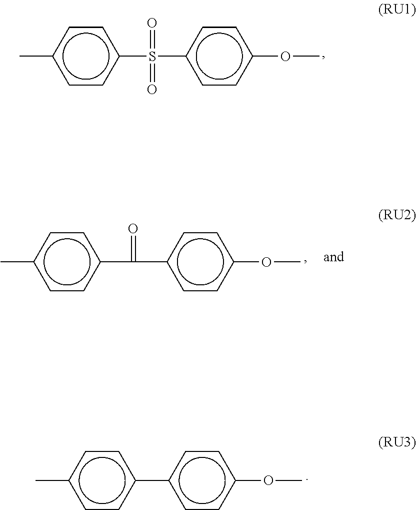
wherein the amorphous polymer (P) comprises
80 to 90% by mole of repeat units (RU1), and
10 to 20% by mole of repeat units (RU2),
based on the total number moles of repeat unit (RU1) and repeat unit (RU2), comprised in the amorphous polymer.

17. The membrane (M) according to claim 16, wherein the membrane (M) comprises at least 70% by weight of the amorphous polymer (P) based on the total weight of the membrane.

18. The membrane (M) according to claim 16, wherein the total weight of repeat units (RU1), (RU2) and (RU3) contained in the amorphous polymer (P) over the total weight of the amorphous polymer (P) ratio is above 0.7.

19. The membrane (M) according to claim 16, wherein the membrane (M) comprises an upper surface comprising pores, and a lower surface comprising pores, wherein the pore sizes increase from the upper surface towards the lower surface.

20. The membrane (M) according to claim 16, wherein the amorphous polymer (P) has a polydiversity (Q) in the range of 2.0 to ≤5.0.

21. The membrane (M) according to claim 16, wherein the amorphous polymer (P) has an average molecular weight (M_{w}) in the range of 14,000 to 120,000 g/mol.

22. The membrane (M) according to claim 16, wherein the amorphous polymer (P) is obtained by the reaction of a 4,4′-dihalogendiphenylsulfone, a 4,4′-dihalobenzophenone and 4,4′-dihydroxybiphenole.

23. The membrane (M) according to claim 16, wherein the amorphous polymer (P) is a statistical copolymer having the following structures (S1) and (S2) 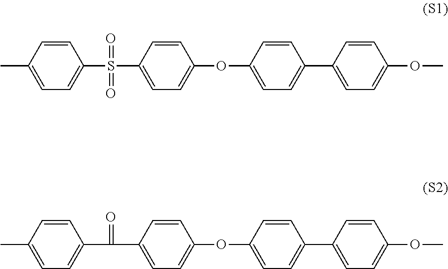
wherein the structures (S1) and (S2) follow a statistical rule.

24. The membrane (M) according to claim 16, wherein the amorphous polymer (P) is a block copolymer having the following structure (S3)

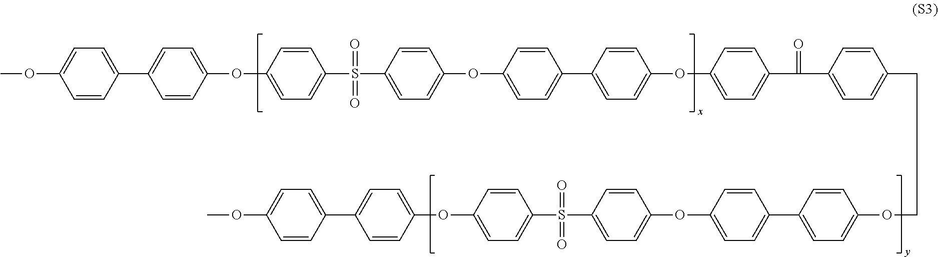

25. A method for the preparation of the membrane (M) according to claim 16, wherein the method comprises the steps
i) providing a solution (S) which comprises the amorphous polymer (P) and at least one aprotic polar solvent,
ii) separating the at least one solvent from the solution (S) to obtain the membrane (M).

26. The method according to claim 25, wherein the at least one solvent is selected from the group consisting of N-methylpyrrolidone, dimethyllactamide, dimethylacetamide, dimethylsulfoxide, dimethylformamide and sulfolane.

27. The method according to claim 25, wherein the solution (S) in step i) comprises from 1 to 30% by weight of the amorphous polymer (P), based on the total of the solution (S).

28. The method according to claim 25, wherein the separation of the at least one solvent (S) in step ii) is carried out via a phase inversion process.

29. A filtration process, wherein a liquid permeates a membrane (M) according to claim 16.

30. A filtration process, wherein a liquid permeates a membrane (M) obtained by the method according to claim 25
